(19) United States
(12) Patent Application Publication
(10) Pub. No.: US 2009/0303018 A1
(43) Pub. Date: Dec. 10, 2009

(54) Electronic label provided with means for reading and displaying rfid chip content

(76) Inventor: Phillippe Catteau, Neuilly Sur Seine (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/988,984

(22) PCT Filed: Jul. 19, 2006
(86) PCT No.: PCT/EP2006/064398

§ 371 Date: Aug. 5, 2009

(30) Foreign Application Priority Data
Jul. 19, 2005 (FR) 0507641

(51) Int. Cl. H04Q 5/22

(52) U.S. Cl. 340/10.6

(57) ABSTRACT

An electronic label of a system for displaying, in particular prices at a sales area. A display screen, a memory for storing displayable data items, an interface provided with a central server of the display system and a processing unit for controlling the storage of data items transmitted from the central server to the memory through the interface and for controlling the display of the data items stored in the memory on the display screen are utilized. The label also includes reader for reading the information items contained in an identification chip by RFID radio frequency. The processing unit is also used for controlling the reading of the information items contained in the RFID chip by the reader and for storing the read information items in the memory in such a way that the information items of the RFID chip are displayable on the display screen of the electronic label by the instruction of the processing unit.

The invention relates to electronic labels for systems for displaying in particular prices and management data in a sales area.

The main purpose of display systems is to make it possible, on the shelves in a site such as a hypermarket, supermarket or any other sales area (for example a pharmacy, etc), to present to the consumers, for each article on sale, a price for which it is known that said price reliably corresponds to the price as it appears in the master file of the shop, i.e. to the price that will effectively be used at the checkout in order to pay for the article. Furthermore, such systems make it possible to make automated price changes within much shorter periods of time than with a manual display, regardless of whether these changes are made for particular promotional periods in the shop, for all or some of the articles, to pass on the cost of rate increases, to combat inflation situations where the prices have to be increased very frequently, etc.

An electronic label for such a display system is generally known by the term electronic shelf label ESL. Such an ESL label typically comprises a display screen (for example in the form of an LCD screen), a memory for storing the data to be displayed, and a microprocessor which is designed in particular to order the display of the data stored in the memory.

Barcodes are generally affixed to the products in the shop, in particular so as to allow identification of said products. However, since the need for traceability of the products is becoming increasingly important, barcodes will in time probably disappear and be replaced by a more high-performance means of identification, namely radiofrequency identification chips or RFID chips.

Each RFID chip has a unique identification number, and each product to which such a chip is affixed can therefore be uniquely identified. In addition to the information for identifying the product to which it is affixed, an RFID chip may contain the following information: date of manufacture, place of manufacture, name of the supplier, name of the carrier, container number, pallet number, transit time, sales unit, packaging unit, storage temperature, product treatment, date when the product was placed on the shelf, etc.

Of course, this list is not exhaustive. Lots of interesting data relating to each of the transformation or movement steps are important to each of the parties involved.

It will be noted that it is necessary to distinguish between “passive” chips which are accessible only for reading purposes, and “active” chips which are accessible both for reading and writing purposes.

In order to be able to access the information contained in an RFID chip, use is made of a reader which is specifically designed to interrogate RFID chips, this reader generally being associated with a display unit which makes it possible to display the information that has been read.

The reader and the associated display unit may be integrated in a portable terminal which is designed to be used by the employees of a shop who have been charged with collecting such RFID information. However, it is then necessary for each of these employees to have such a terminal available at all times. This results in a potentially high cost with regard to the equipment for the employees. Furthermore, the employee must always carry this terminal with him, which may prove to be impractical (risk of loss, bulky size, etc.).

The reader and the associated display unit may also be integrated in a terminal which is designed to be installed in a shop. The employee then has to take the product to the terminal in order to gain access to the information contained in the RFID chip associated with the product. Such an operation may prove to be tiresome for the employee, particularly when it is carried out on a frequent basis (distance from the shelf to the terminal, weight of the product). In any case, it results in a loss of time.

There is therefore a need for a device which makes it possible to obtain the information contained in RFID chips affixed to products, which does not exhibit the aforementioned disadvantages of the prior art.

The object of the invention is to meet this need, and to this end the invention proposes an electronic label for a system for displaying in particular prices in a sales area, comprising a display screen, a memory for storing data to be displayed, interface means for interfacing with a central server of the display system, and a processing unit which is designed to control the storage in the memory of the data transmitted by the central server via the interface means and to order the display of the data stored in the memory on the display screen, characterised in that said electronic label furthermore comprises reading means for reading the information contained in a radiofrequency identification chip or RFID chip, and in that the processing unit is also designed to order the reading by said reading means of the information contained in an RFID chip and the storage in the memory of said information that has been read, so that the information from an RFID chip can be displayed on the display screen of the electronic label at the request of the processing unit.

Some preferred but non-limiting aspects of this label are as follows:
the RFID reading means are proximity reading means which are designed to be able to read the content of an RFID chip which is brought close to said reading means;
it comprises means for controlling the reading distance of the RFID reading means, and the processing unit is also designed to control said means for controlling the reading distance;
it comprises means for detecting the presence of an RFID chip within its reading range;
the memory comprises a first location reserved for the storage of the data coming from the central server of the display system, and a second location reserved for the storage of the data read from one or more RFID chips;
the displaying of the information contained in an RFID chip is ordered by the processing unit once a display command has been sent to said processing unit via the interface means;
the displaying of the information contained in an RFID chip is carried out automatically by the processing unit;
the processing unit is also designed to order the standby, and reciprocally the activation, of the reading means once a standby or activation command has been sent to said processing unit via the interface means;
the processing unit is also designed to order a timed display of said RFID information;
the processing unit is also designed to process the RFID information stored in the memory;
the processing unit is also designed to transmit the RFID information stored in the memory to the central server, and to receive from the central server supplementary information relating to said RFID information for storage and/or processing and/or display;
the address of the label corresponds to all or part of the identifier of the RFID chip.

Other aspects, objects and advantages of the present invention will become more apparent on reading the following detailed description of some preferred embodiments thereof, said description being given by way of non-limiting example and with reference to the appended drawings, in which:

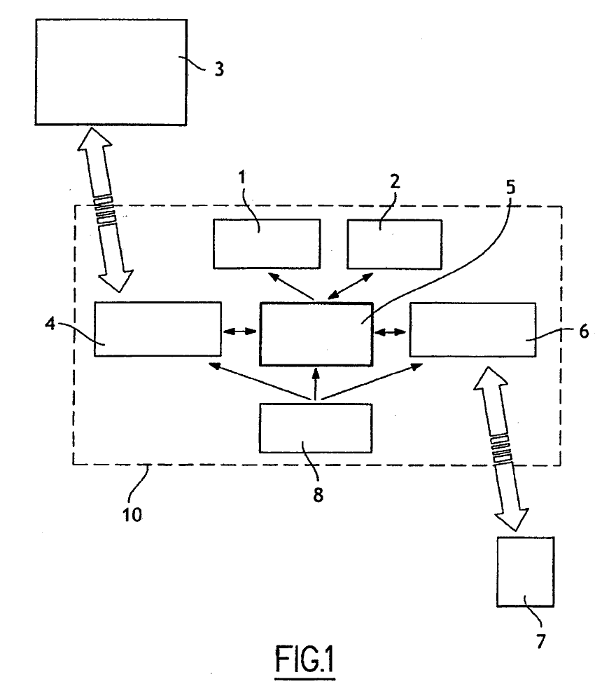

FIG. 1 is a diagram of a label according to one possible embodiment of the invention;

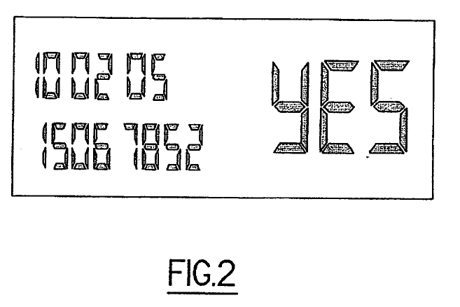

FIG. 2 shows the type of information read from an RFID chip and able to be displayed on a label according to the invention.

The aim of the invention is to make it possible to provide the employees and/or customers of a sales area with information relating to the products located in this sales area. More specifically, the aim is to provide a tool which makes it possible to manage the shelves (knowledge of the identifier of a product, stock, replenishment, etc.) as well as the location and traceability of the products.

The “product” information to which the invention relates is more specifically information which is contained in a radiofrequency identification chip or RFID chip attached to a product.

By extension, this information is also information which is stored on a central server of the display system (such as price, loyalty rewards, etc.) and which can be made available after reading supplementary information contained in an RFID chip.

The invention proposes a new type of electronic shelf label. Means for reading RFID chips are integrated in the label according to the invention so as to make it possible to read the content of the RFID chip and to display this content, or else information derived from this content (for example either by calculation or by retrieving supplementary information stored in the server), on the screen of the label.

All the electronic labels of the display system of a sales area may be labels according to the invention. Of course, it is possible that only some of the electronic labels installed in a sales area are according to the invention, for example one label according to the invention per shelf, or one per rack, or even one per aisle.

FIG. 1 schematically shows an electronic label 10 according to one possible embodiment of the invention.

The label 10 according to the invention comprises a display screen 1, typically in the form of an LCD screen. The screen may have one or more zones for allowing the simultaneous display of several different information items.

The label 10 also comprises a memory 2 for storing data to be displayed. The memory may of course consist of different memory areas, it being possible for each area to be assigned to the storage of a particular type of data. By way of example, the memory of a conventional ESL label, of the type proposed by the Applicant, may comprise 13 different memory areas.

The display system comprises a central server 3 which is connected, for example via a wireless link, to all the labels of the display system of the sales area. It will be recalled here that the display system may comprise both labels according to the prior art and labels according to the present invention.

Interface means 4 for interfacing with the central server 3 are provided in the label 10 (for example means able to provide a wireless link) so as to allow the exchange of data between the label 10 and the central server 3.

It should be specified that the interface means 4 are not limited to the exchange of data between the label 10 and the central server 3, but also extend to the exchange of data between the label 10 and a portable terminal or a remote control specially provided for this purpose.

The processing unit 5 is designed to control the storage in the memory 2 of the data transmitted to the label 10 by the central server 3 via the interface means 4 and to order the display of the data stored in the memory on the display screen 1.

Besides information intended to be stored in the memory, the central server 3 may send “commands” to the label 10 via the interface means 4, these commands being interpreted and implemented by the processing unit 5.

To this end, different communication modes are provided between the central server 3 and the different labels 10 according to the invention in the display system.

A first communication mode consists in the sending of a unique message by the central server 3 to a single label 10. Such a unique message may of course be sent to a number of labels, the latter then being addressed one after the other.

Another communication mode consists in the sending of a semi-generic message to all the labels.

Yet another communication mode consists in the sending of a generic message to all the labels.

Returning to the description of the label 10, the latter also comprises reading means 6 for reading the information contained in a radiofrequency identification chip or RFID chip 7.

The RFID reading means 6 may be proximity reading means which are designed to be able to read the content of an RFID chip which is brought close to said reading means. “Close” is typically understood to mean a distance from around a few millimetres to a few centimetres.

It will be noted that, associated with the reading means, the label 10 may comprise means for detecting the presence of an RFID chip within its reading range.

Furthermore, the label 10 may also comprise means (not shown) for controlling the reading distance of the RFID reading means 6, the processing unit 5 being designed to control said means for controlling the reading distance.

The means for controlling the reading distance may be ordered to vary the power or frequency of the RFID reading means so as to vary the reading distance.

By way of example, a low power makes it possible to define a proximity reading mode, from around a few millimetres to a few centimetres. The use of a high power or the use of a different frequency range allows remote reading, typically at a distance from around a few tens of centimetres to a few metres.

“Proximity” reading allows reading of the content of an RFID chip affixed to a product only if this product is deliberately passed close to the label 10.

“Remote” reading makes it possible to automatically read the content of a plurality of RFID tags, typically all the tags affixed to products on the same rack. Preferably, when this “remote” reading mode is implemented, the label 10 comprises means for managing conflicts between the responses from the different RFID chips that are interrogated by the label because they are located within the reading range of the reading means.

Within the context of a proximity reading mode, it is possible for a product and therefore the associated RFID chip to be located close to the label 10, thus triggering the permanent reading of the content of the chip. This results in a continuous and potentially high consumption of power. Furthermore, when the processing unit 5 is designed to display the content of an RFID chip as soon as said chip is within the reading range of the reading means, the information contained in the chip will be displayed permanently on the display screen, to the detriment of conventional ESL data (typically price information) which are nevertheless required by the consumer.

In order to remedy these drawbacks, the invention proposes that the processing unit 5 is designed so that the content of one and the same RFID chip (with an associated unique identifier) cannot be read more than a certain number of times (adjustable) in succession. In such a case, the RFID reading means are controlled by the processing unit 5 so as to be placed on standby for a given duration, or until a chip with a different identifier is read.

Additionally or as an alternative, the invention proposes that the processing unit 5 is also designed to order the standby, and reciprocally the activation, of the reading means 6 once a standby or activation command has been sent to said processing unit via the interface means 4. This standby/activation command may be sent remotely by the central server or in proximity by a portable terminal or a remote control provided to enter into a dialogue with the label.

By way of example, the RFID reading means may be activated in the morning before opening the shop to the public, and may be placed on standby once the shop is open.

Another example is that of the remote or proximity activation of the reading means, the latter being on standby in their normal state.

The processing unit 5 of the label 10 is also designed to order the storage in the memory 2 of the information that has been read by said reading means 6, so that the information from an RFID chip can be displayed on the display screen of the label 10 at the request of the processing unit 5.

By storing the RFID information in the memory 2 of the label 10, the displaying of these data on the screen 1 can thus take place in the same way as for the other data (i.e. the data conventionally displayed by an ESL label of the prior art and typically coming from the central server) under the control of the processing unit 5.

The display can thus be triggered by an order (sending of a command to display the RFID information) from the central server 3 (in particular via a wireless link), or an order from a device such as a portable terminal or remote control conventionally used to control an ESL label of the prior art.

It may also be a display that is carried out automatically, the processing unit being designed to automatically order the display, for example as soon as an RFID chip has come into the proximity of the label according to the invention, or else at a defined time.

The RFID information may be displayed in a static manner (fixed display) or in a dynamic manner (in a scrolling fashion or alternating with other information).

FIG. 2 shows an example of the displaying on the screen of information contained in an RFID chip. The information here is displayed in three separate display zones on the screen, and respectively show:
maintenance of the cold chain (“YES”);
the product sell-by date (“10 02 05”);
the identifier of the RFID chip (“15067852”).

The RFID information can thus be displayed on the screen 3 and can be represented either by text or by symbols (which may or may not be specific to this RFID information), or by using the digits, segments and symbols conventionally used in an ESL label of the prior art.

According to one particular embodiment of the invention, the memory may comprise a first location reserved for the storage of the data coming from the central server 3 (conventional ESL data), and a second location reserved for the storage of the information read from one or more RFID chips (RFID information).

These first and second locations may of course comprise one or more of the “memory areas” constituting the memory 2 as mentioned above.

The processing unit 5 is also designed to make it possible to order the display of data stored in the memory 2 in a given sequence, that is to say by successively displaying, for a given duration, some of the information stored in the memory 2. It is possible for example to provide for the successive display of price information (conventional ESL data) followed by RFID information. It is also possible to provide for the simultaneous display on the screen of the ESL data and the RFID information, by using for this purpose a screen which has a plurality of display zones.

Of course, the processing unit 5 is able to process the data stored in the memory, and can therefore carry out calculations both on the basis of conventional ESL data and on the basis of RFID information.

Such processing capabilities make it possible for the label 10 to calculate information itself, without it being necessary for this to be done elsewhere.

These calculation capabilities can thus be used, in a manner that is conventional per se, to process the data communicated to the label by the central server 3 of the display system. One example of a calculation carried out on conventional ESL data is that of currency conversion.

Within the context of the present invention, these calculation capabilities are advantageously used to process the RFID information, for example in order to create an inventory (counting of a number of products), to determine the time that a product has spent on the shelf, to determine the time left before the use-by date, etc.

These processing capabilities can also be used so that the reading of an RFID chip, as already mentioned above, leads to the retrieval of supplementary information stored on the central server and the display of the information thus retrieved (price, loyalty rewards, etc.).

According to one particular embodiment of the invention, the address of a label 10 (which is used to address a label in particular with a view to the sending of a command and/or a transmission of data by the central server 3) corresponds to all or part of the identifier of the RFID chip of a product associated with the label.

Typically, a number of products with the same article reference are presented on a shelf in a sales area. The invention provides that the RFID chip associated with a product has an RFID identifier comprising a generic part, which is common to all the products with the same article reference, and a unique part which makes it possible to identify each product individually (in particular for traceability purposes).

In such a case, the invention provides that the address of the label 10 corresponds to the generic part of the identifiers of the products with which the label is associated.

It is of course possible to provide that the address of the label corresponds to the whole identifier of a product, in which case an IT link is used to link the other products (with the same article reference) to this label.

Furthermore, the label 10 comprises a power source 8, for example in the form of one or more batteries, or else a power source of the photovoltaic type.

Advantageously, within the context of the present invention, the power source 8 provides a supply of power to the processing unit 5, the interface means 4 and the RFID reading means 6.

The label 10 is typically housed in a casing, and advantageously the RFID reading means 6 are integrated in this casing. In such a case, it is not necessary to provide a specific casing for accommodating the reading means 6. The reading means 6 are then not visible from outside, which helps to improve, or at the very least not to impair, the aesthetic appearance of the shelves of the sales area.

Of course, the invention is not limited to such an integration and also extends to the case where the reading means 6 are arranged outside the casing of the label.

If the RFID reading means 6 are integrated in the casing of the label 10, a distinctive sign may then be attached to the casing so as to make it possible to identify those labels in the sales area which, according to the present invention, comprise such reading means and are able in particular to allow the reading and display of information contained in an RFID chip.

Finally, it should be specified that the main benefit of the label according to the invention is that of making product information available to shop employees. The invention also provides that some data are accessible to consumers, either by reading the RFID chip of a product handled by the consumer so as to bring the label closer, or by interrogating the memory (and in particular a memory area which stores RFID information accessible to the consumers), for example by means of a remote control, or by pressing a button provided for this purpose on the casing of the label.

By way of example, the following information may be read from an RFID chip and displayed on the screen:
sell-by date (SBD)
use-by date (UBD)
indicator of a break in the cold chain.

Also by way of example, it will be noted that, via the interface means 4 for interfacing with the central server 3, the user (consumer or employee) can present a product equipped with an RFID chip 7 in front of the label 10 and can obtain confirmation on the screen 1 of the selling price of said product. The interface means, the central server, the processing unit, the screen and the memory of the electronic label are thus used to display the price of an article other than that initially associated with the label.

1. An electronic label (10) for a system for displaying in particular prices and management data in a sales area, comprising a display screen (1), a memory (2) for storing data to be displayed, interface means (4) for interfacing with a central server (3) of the display system, and a processing unit (5) which is designed to control the storage in the memory (2) of the data transmitted by the central server (3) via the interface means (4) and to order the display of the data stored in the memory (2) on the display screen (1), wherein said electronic label furthermore comprises reading means (6) for reading the information contained in a radiofrequency identification chip or RFID chip (7), and wherein the processing unit (5) is also designed to order the reading by said reading means (6) of the information contained in an RFID chip (7) and the storage in the memory (2) of said information that has been read, so that the information from an RFID chip (7) can be displayed on the display screen (1) of the electronic label (10) at the request of the processing unit (5).

2. A label according to claim 1, wherein the RFID reading means (6) are proximity reading means which are designed to be able to read the content of an RFID chip (7) which is brought close to said reading means (6).

3. A label according to claim 1, further comprising means for controlling the reading distance of the RFID reading means, and in that the processing unit (5) is also designed to control said means for controlling the reading distance.

4. A label according to claim 3, comprising means for detecting the presence of an RFID chip within its reading range.

5. A label according to claim 1, wherein the memory (2) comprises a first location reserved for the storage of the data coming from the central server of the display system, and a second location reserved for the storage of the data read from one or more RFID chips.

6. A label according to claim 1, wherein the displaying of the information contained in an RFID chip (7) is ordered by the processing unit (5) once a display command has been sent to said processing unit (5) via the interface means (4).

7. A label according to claim 1, wherein the displaying of the information contained in an RFID chip (7) is carried out automatically by the processing unit (5).

8. A label according to claim 1, wherein the processing unit (5) is also designed to order the standby, and reciprocally the activation, of the reading means (6) once a standby or activation command has been sent to said processing unit (5) via the interface means (4).

9. A label according to claim 1, wherein the processing unit (5) is also designed to order a timed display of said RFID information.

10. A label according to claim 1, wherein the processing unit (5) is also designed to process the RFID information stored in the memory (2).

11. A label according to claim 1, wherein the processing unit (5) is also designed to transmit the RFID information stored in the memory (2) to the central server, and to receive from the central server supplementary information relating to said RFID information for storage and/or processing and/or display.

12. A label according to claim 1, wherein the address of said label corresponds to all or part of the identifier of the RFID chip.
